(19) United States
(12) Patent Application Publication
(10) Pub. No.: US 2010/0319827 A1
(43) Pub. Date: Dec. 23, 2010

(54) TIRE WITH METALLIZED ORGANIC SHORT FIBERS

(76) Inventors: Serge Julien Auguste Imhoff, Schrondweiler (LU); Julia Martine Francoise Claudine Tahon, Bereldange (LU); Ralf Mruk, Colmar-Berg (LU)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/423,981

(22) Filed: Jun. 19, 2009

(51) Int. Cl. B60C 9/12

(52) U.S. Cl. 152/458; 152/565

(57) ABSTRACT

The present invention is directed to a pneumatic tire including at least one component. The component includes a rubber composition. The rubber composition includes a diene based elastomer and from 1 to 100 parts by weight of a metallized organic short fiber, per 100 parts by weight of elastomer. The organic short fibers having a length from 1 mm to 5 mm. Both the length and the ends of the short fibers are completely coated with a layer of metal or metal alloy.

### FIELD OF THE INVENTION

The present invention is directed to a pneumatic tire. More specifically, the present invention is directed to a pneumatic tire with one component comprising metallized organic short fibers.

### BACKGROUND OF THE INVENTION

Conventional tires utilize short or chopped fibers for reinforcing various rubber components of the tire. The short/chopped fibers have been typically first dipped in adhesive and subsequently chopped and added to the rubber. The adhesive allows the fibers to adhere to the rubber matrix. However, the bare cut ends often lead to micro-cracks when the component incurs tension or compression, since the bare cut ends of the fibers, having no adhesive layer, are in direct contact with the rubber matrix and thereby have little or no adhesion to the rubber matrix. Therefore, it would be desirable to improve adhesion of the short fibers with the rubber matrix.

### SUMMARY OF THE INVENTION

A pneumatic tire in accordance with the present invention includes at least one component. The component includes a rubber composition. The rubber composition includes a diene based elastomer and from 1 to 100 parts by weight of a metallized organic short fiber, per 100 parts by weight of elastomer. The organic short fibers having a length from 1 mm to 5 mm. Both the length and the ends of the short fibers are completely coated with a layer of metal.

In one aspect of the present invention, the component is a sidewall disposed radially inward of a ply layer of the pneumatic tire.

In another aspect of the present invention, the component is an apex disposed radially outward of a bead of the pneumatic tire.

In still another aspect of the present invention, the component is a wedge insert disposed axially inward of a sidewall of the pneumatic tire.

In yet another aspect of the present invention, the component is a base compound of a tread of the pneumatic tire.

In still another aspect of the present invention, the short fibers comprise an organic material selected from the group consisting of PBO, aramid, glass fiber, carbon fiber, nylon, cellulose fibers including rayon and Lyocell, polyester, and polyketone.

In yet another aspect of the present invention, a material for the layer of metal or metal alloy is selected from the group consisting from nickel, copper, gold, brass, and silver.

In still another aspect of the present invention, the diene based elastomer is selected from the group consisting of natural rubber, synthetic polyisoprene, polybutadiene, and styrene-butadiene rubber.

In yet another aspect of the present invention, the short fibers comprise a material selected from the group consisting of polyvinyl alcohol, acrylic, and polypropylene fibers.

### DEFINITIONS

The following definitions are controlling for the disclosed invention.

“Apex” means an elastomeric filler located radially above the bead core and between the plies and the turnup ply.

“Annular” means formed like a ring.

“Aspect ratio” of the tire means the ratio of its section height to its section width multiplied by 100% for expression as a percentage.

“Axial” and “axially” means lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim. The radially inner beads are associated with holding the tire to the wheel rim.

“Belt structure” means at least one annular layers or plies of parallel cords, woven or unwoven, underlying the tread, unanchored to the bead, and having both cord angles in the range from 17 degrees to 28 degrees with respect to the equatorial plane of the tire.

“Carcass” means the tire structure apart from the belt structure, tread, undertread, and sidewall rubber over the plies, but including the beads.

“Circumferential” means lines or directions extending along the perimeter of the surface of the annular tire parallel to the Equatorial Plane (EP) and perpendicular to the axial direction.

“Contact Patch” means a section of footprint, in a footprint that is divided into sections by wide void areas, that maintains contact with the ground.

“Design rim” means a rim having a specified configuration and width. For the purposes of this specification, the design rim and design rim width are as specified by the industry standards in effect in the location in which the tire is made. For example, in the United States, the design rims are as specified by the Tire and Rim Association. In Europe, the rims are as specified in the European Tyre and Rim Technical Organization—Standards Manual and the term design rim means the same as the standard measurement rims. In Japan, the standard organization is The Japan Automobile Tire Manufacturer's Association.

“Equatorial plane (EP)” means the plane perpendicular to the tire's axis of rotation and passing through the center of its tread.

“Footprint” means the contact patch or area of contact of the tire tread with a flat surface at zero speed and under normal load and pressure.

“Inner” means toward the inside of the tire and “outer” means toward its exterior.

“Lateral” means an axial direction.

“Lateral Edge” means the axially outermost edge of the tread as defined by a plane parallel to the equatorial plane and intersecting the outer ends of the axially outermost traction lugs at the radial height of the inner tread surface.

“Normal Inflation Pressure” means a specific design inflation pressure and load assigned by the appropriate stands organization for the service condition for the tire.

“Outer” means toward the tire's exterior.

“Radial” and “radially” mean directions radially toward or away from the axis of rotation of the tire.

“Shoulder” means the upper portion of sidewall just below the tread edge, effects cornering. Tread shoulder or shoulder rib means that portion of the tread near the shoulder.

“Sidewall” means that portion of a tire between the tread and the bead.

“Tread Pressure” means the distribution of load across the footprint area of tire.

“Tread Width” means the arc length of the tread surface in the axial direction, that is, in a plane parallel to the axis of rotation of the tire.

“Turn-up ply” means an end of a carcass ply that wraps around one bead only.

### BRIEF DESCRIPTION OF THE DRAWINGS

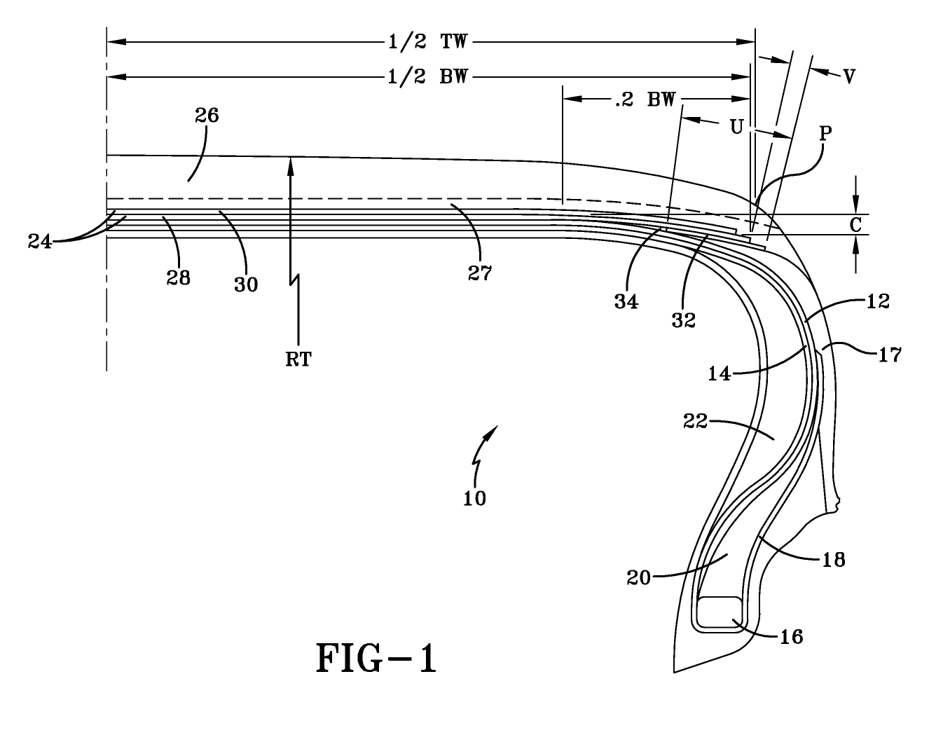

The invention will be described by way of example and with reference to the accompanying FIG. 1, in which is illustrated a cross sectional view of an example tire for use with the present invention.

### DETAILED DESCRIPTION OF THE INVENTION

The following language is of the best presently contemplated mode or modes of carrying out the invention. This description is made for the purpose of illustrating the general principles of the invention and should not be taken in a limiting sense. The scope of the invention is best determined by reference to the appended claims.

Referring now to FIG. 1, there is shown in cross sectional view a segment of an example molded, self-supporting radial ply tire 10 incorporating for use with the present invention. The non-illustrated half of the example tire 10 is symmetrical to that illustrated. The carcass has at least one radial ply layer forming the primary reinforcing structure to the example tire 10. In this tire 10, the carcass has an outer radial ply layer 12, an inner radial ply layer 14, together comprising a radial ply carcass structure. The turnup end 18 of the inner radial ply layer 14 is wrapped about an inextensible annular bead 16 with the terminal ends of the ply layer being radially inward and axially outward of a belt structure 24.

To space the turn-up ply 18 of the inner radial ply layer 14 from the outer radial ply layer 12, an apex 20 may be placed radially outward of the annular bead 16. Radially inward of the ply layers 12, 14, in each sidewall 17, is a sidewall wedge insert 22. The sidewall wedge insert 22 may provide the example tire 10 with run-flat, self-supporting capabilities. Though FIG. 1 shows a self-supporting run-flat tire design, it is also contemplated that the present invention may be incorporated in non self-supporting type tires or other types of run-flat or non-run-flat tires.

A tread 26 and the belt structure 24 are disposed radially outward of the carcass ply layers 12, 14. The tread 26 may have a base compound 27 for stabilizing a footprint of the tire 10 under severe handling conditions. The belt structure 24 has at least one radially innermost ply 28 of parallel cords that is directly adjacent to the outermost radial carcass ply layer 12 for the majority of its axial width. Outward of the innermost ply 28 may be at least one more belt ply 30 of parallel cords. The parallel cords of the adjacent belt layer 30 are preferably inclined at an equal, but opposite, angle from the inclination of the cords in the innermost belt ply 28.

In the lateral regions of the example tire 10, the radially innermost belt ply 28 is distanced from the carcass plies 12, 14 as the carcass ply path follows the outer contour of the run-flat insert 22. In the outer 20% of the belt width BW, the belt plies 28, 30 curve radially inward. The belt ply radial drop C may be defined as the drop of the centerline of the belt structure 24 from a point at 20% of the belt width BW to the axially outermost point of the belt center line. The belt ply radial drop C may influence heel and toe wear of the tire 10. A lower belt ply radial drop C may improve the heel and toe wear of the tread 26.

The belt structure 24 of the example tire 10 may have a width BW of at least 95% of the tread width TW. The tread width TW may be measured from a shoulder drop point P along an outer profile of the example tire 10. A wider belt structure 24 may increase the high speed performance of the tire 10, but may also necessitate a structure for maintaining the belt edges at a desired profile and a minimized belt ply radial drop C.

The outer surface of the tread 26 may be defined by a smoothly continuous profile. The example tread 26 is illustrated with no grooves. However, those skilled in the art will appreciate that the tread 26 may be grooved in any number of tread patterns. Whatever groove pattern is selected, the surface of the tread 26 may have the disclosed surface profile. In the central region of the tread 26, the profile defined by a radius of curvature RT, which may be similar to the belt profile curvature, creating a substantially constant tread thickness. At the lateral tread edges, in the shoulders of the tire 10, the tread thickness may decrease, and the radii defining the tread profile may decrease.

To maintain the spacing between the lateral edges of the belt structure 24 and the carcass plies 12, 14 in the shoulder region of the tire 10, a rubber wedge may be inserted into the spacing. To improve high speed durability of the example tire 10, the spacing may be partly maintained by an annular reinforcing strip layer 32 located radially inward of the lateral edges of the radially innermost belt layer 28. The reinforcing strip layer 32 may have a width U that prevents the belt layers 28, 30 from lifting at an inside edge 34 of the reinforcing strip layer. A width U of the strip layer 32 may be at least 5 mm and not greater than 30 mm. If the width U of the layer 32 is greater than 30 mm, a bend in the belt structure 24 may occur.

In accordance with the present invention, metallized organic short fibers may be used as anisotropic reinforcement for one or more components of a tire, such as the example tire 10 of FIG. 1. The excellent tensile properties of organic short fibers produce improved fiber-reinforced compounds with improved anisotropic mechanical properties. Metallized fibers are particularly useful, since the metallic coating does not modify the mechanical properties of the fibers, as adhesives typically do.

Conventionally, fibers have been dipped and then chopped. The longitudinal surface of such fibers may have acceptable adhesion with a rubber matrix, but the bare, uncoated cut ends may lead to micro-cracks in the rubber matrix under tension-compression loads, since the rubber matrix is in direct contact with the uncoated, cut ends of the fibers and thus has little or no adhesion to those ends.

Short fibers in accordance with the present invention provide complete coating of the short fibers, including the ends, with a metallic layer thereby producing enhanced adhesion, or affinity, with the rubber matrix. The micro-cracks described above are greatly mitigated, if not completely eliminated under tension-compression loads.

The short fibers may be electrochemically coated with a metal layer, as performed by Soliani EMC of Como, Italy (www.solianiemc.com), for example. Metals or metal alloys for the coating of the textile surface may include nickel, copper, gold, brass, silver, and/or other suitable metal. Adhesion of the metallized short fibers to the compound matrix may be assured by the same coat compound ingredients as required for the adhesion of brass or bronze plated steel reinforcements (i.e., cobalt salt). The adhesion between the organic fiber surface of the short fibers and the metal coating may be provided by interactions of metal ions or atoms on the fiber surface.

Materials for the short fibers may be PBO, aramid, glass fiber, carbon fiber, nylon, cellulose fibers including rayon and Lyocell, polyester, polyketone, or other suitable organic materials. Further materials for the short fibers may be polyvinyl alcohol, acrylic, and polypropylene fibers. The short fibers may be utilized, for example, in the sidewall 17, the apex 20, the insert 22, the base compound 27, etc. of the tire 10. The length of the short fibers may range, for example, from 1 mm to 5 mm with an average of 3 mm. The diameter of the short fibers may range from 5 microns to 30 microns. The introduction of the completely metallized organic short fibers, in accordance with the present invention, into a tire component may lead to improved anisotropic mechanical properties of that component and thereby improve overall tire performance.

As stated above, rubber components for use in pneumatic tires are sometimes reinforced with these short textile/organic fibers. In general, the presence of short fibers in a cured rubber compound results in an increase in initial or low strain (low elongation) modulus (stiffness). Concomitantly, the presence of conventional short fibers in rubber often times results in reduced fatigue endurance and higher hysteretic heat build-up under periodic stresses.

Improvement in the performance of tires containing short fibers has been obtained by treating the surface of the fibers with chemical adhesives to improve the adhesion between the fiber and the rubber. However, such chemical surface treatments do not always result in the desired performance. Further, composite materials may comprise reinforcing elements (i.e., short or chopped fibers of glass, carbon, boron, polyamide etc.) and a joining matrix such as rubber. The properties of such a composite material may particularly depend upon on the orientation of the reinforcing elements, the distribution of the rubber matrix throughout the volume between the reinforcing elements, and the bond induced between the reinforcing elements and the matrix. Thus, short fiber reinforcement of components in accordance with the present invention may improve impact/puncture resistance of the sidewall 17, improve ride and handling characteristics produced by the apex 20 or wedge insert 22, improve stabilization of the footprint produced by the base compound 27, etc.

While certain representative embodiments and details have been shown for the purpose of illustrating the invention, it will be apparent to those skilled in this art that various changes and modifications may be made therein without departing from the spirit or scope of the invention.

What is claimed is:

1. A pneumatic tire comprising at least one component, the at least one component comprising a rubber composition, the rubber composition comprising a diene based elastomer and from 1 to 100 parts by weight of a metallized organic short fiber, per 100 parts by weight of elastomer, the organic short fibers having a length from 1 mm to 5 mm,
both the length and the ends of the short fibers being coated with a layer of metal or metal alloy.

2. The pneumatic tire as set forth in claim 1 wherein the component is a sidewall disposed radially inward of a ply layer of the pneumatic tire.

3. The pneumatic tire as set forth in claim 1 wherein the component is an apex disposed radially outward of a bead of the pneumatic tire.

4. The pneumatic tire as set forth in claim 1 wherein the component is a wedge insert disposed axially inward of a sidewall of the pneumatic tire.

5. The pneumatic tire as set forth in claim 1 wherein the component is a base compound of a tread of the pneumatic tire.

6. The pneumatic tire as set forth in claim 1 wherein the short fibers comprise an organic material selected from the group consisting of PBO, aramid, glass fiber, carbon fiber, nylon, cellulose fibers, polyester, and polyketone.

7. The pneumatic tire as set forth in claim 1 wherein a material for the layer of metal or metal alloy is selected from the group consisting from nickel, copper, gold, brass, and silver.

8. The pneumatic tire as set forth in claim 1 wherein the diene based elastomer is selected from the group consisting of natural rubber, synthetic polyisoprene, polybutadiene, and styrene-butadiene rubber.

9. The pneumatic tire as set forth in claim 1 wherein the short fibers comprise a material selected from the group consisting of polyvinyl alcohol, acrylic, and polypropylene fibers.
